(19) United States
(12) Patent Application Publication
(10) Pub. No.: US 2005/0207298 A1
(43) Pub. Date: Sep. 22, 2005

(54) Disk drive device

(75) Inventor: Susumu Seino, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/071,232

(22) Filed: Mar. 4, 2005

(30) Foreign Application Priority Data
Mar. 19, 2004 (JP) P2004-081372

(51) Int. Cl. G11B 7/00

(52) U.S. Cl. 369/47.52; 369/59.11

(57) ABSTRACT

This invention makes it possible to increase a recording transfer rate while keeping recording characteristics with simple control, regardless of change of linear velocity. According to this invention, when data is written on or erased from an optical disk 100, a write pulse on a temporal axis is corrected by using a recording strategy suitable for a linear velocity, without adjusting write power set in consideration of the recording characteristics of the optical disk 100. Therefore, this invention can increase a recording transfer rate with keeping the same recording characteristics, with simple control of only correction of the write pulse on the temporal axis, regardless of change of the write pulse.

### BACKGROUND OF THE INVENTION

1. Field of the Invention

This invention relates to a disk drive device and is suitably applied to a disk drive device which writes or erases data on/from an optical disk, for example.

2. Description of the Related Art

To write data on an optical disk with a Constant Angular Velocity (CAV) method, there is such a disk drive device that changes write power of laser light to be emitted to the disk recording surface, depending on a linear velocity because a disk outer circumference and a disk inner circumference have different linear velocities. In addition, in writing the data on the optical disk, this disk drive device changes an irradiation time and so on depending on a linear velocity based on data (hereinafter, referred to as recording strategy) specifying an amount of correction on a temporal axis and an amount of waveform correction such as pulse width correction, thereby obtaining a high-quality reproduced signal for each linear velocity (for example, refer to Japanese Patent Laid Open No. 2003-59047.)

### SUMMARY OF THE INVENTION

By the way, since optimum write power to write data is different depending on a linear velocity in the CAV method, this disk drive device requires troublesome and complicated control such as changing write power for each linear velocity by performing calibration (write power adjustment) at least twice for both disk inner circumference and disk outer circumference and interpolating write power for the other circumferences therebetween.

As a result, this disk drive device has a drawback in which it takes time to perform the write-power calibration and thus a recording transfer rate of the drive device deteriorates.

This invention has been made in view of foregoing and intends to propose a disk drive device capable of increasing a recording transfer rate while keeping recording characteristics with simple control.

To solve the above problem, this invention provides a disk drive device for accessing a disk recording medium, with: a driving means for rotating the disk recording medium; an access means for writing or erasing data on/from the disk recording medium with a write pulse, the disk recording medium being rotated by the driving means; a write power setting means for setting write power in consideration of recording characteristics for writing data on the disk recording medium at a prescribed linear velocity; and a control means for correcting the write pulse on a temporal axis with the write power fixed even when the linear velocity of the disk recording medium varies, when the access means writes or erases the data on/from the disk recording medium.

When data is written on or erased from a disk recording medium, a write pulse on a temporal axis is changed according to change of linear velocity with fixing write power set in consideration of recording characteristics of the disk recording medium, thus being capable of increasing a recording transfer rate while always keeping the same recording characteristics with simple control which corrects only the write pulse on the temporal axis, regardless of the change of linear velocity.

Further, this invention provides a disk access method for accessing a disk recording medium with: a write power setting step of setting write power in consideration of recording characteristics for writing data on the disk recording medium at a prescribed linear velocity when data is written on or erased from the disk recording medium with a write pulse, the disk recording medium being rotated by a driving means; and a control step of correcting the write pulse on a temporal axis with the write power fixed even when the linear velocity of the disk recording medium varies, when the data is written on or erased from the disk recording medium.

When data is written on or erased from a disk recording medium, a write pulse on a temporal axis is corrected according to change of linear velocity with fixing write power set in consideration of recording characteristics of the disk recording medium. Therefore, a recording transfer rate can be increased with keeping the same recording characteristics, with simple control which corrects only the write pulse on the temporal axis, regardless of the change of linear velocity.

According to this invention, when data is written on or erased from a disk recording medium, a write pulse on a temporal axis is corrected according to change of linear velocity with write power fixed, the write power set in consideration of recording characteristics of the disk recording medium. Therefore, a disk drive device and a disk access method can be realized, which are capable of increasing a recording transfer rate with keeping the same recording characteristics, with simple control which controls only the write pulse on the temporal axis, regardless of change of linear velocity.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic block diagram showing a construction of a disk drive device of this invention;

FIG. 2 is a schematic view explaining an amplitude reference value and a reproduced signal value;

FIG. 3 is a schematic view explaining a strategy table;

FIG. 4 is a schematic view explaining laser modulation data;

FIG. 5 is a flowchart showing a recording control procedure; and

FIG. 6 is a characteristic curve graph showing recording/reproducing characteristics.

### DETAILED DESCRIPTION OF THE EMBODIMENT

Preferred embodiments of this invention will be described with reference to the accompanying drawings:

(1) Entire Construction of Disk Drive Device

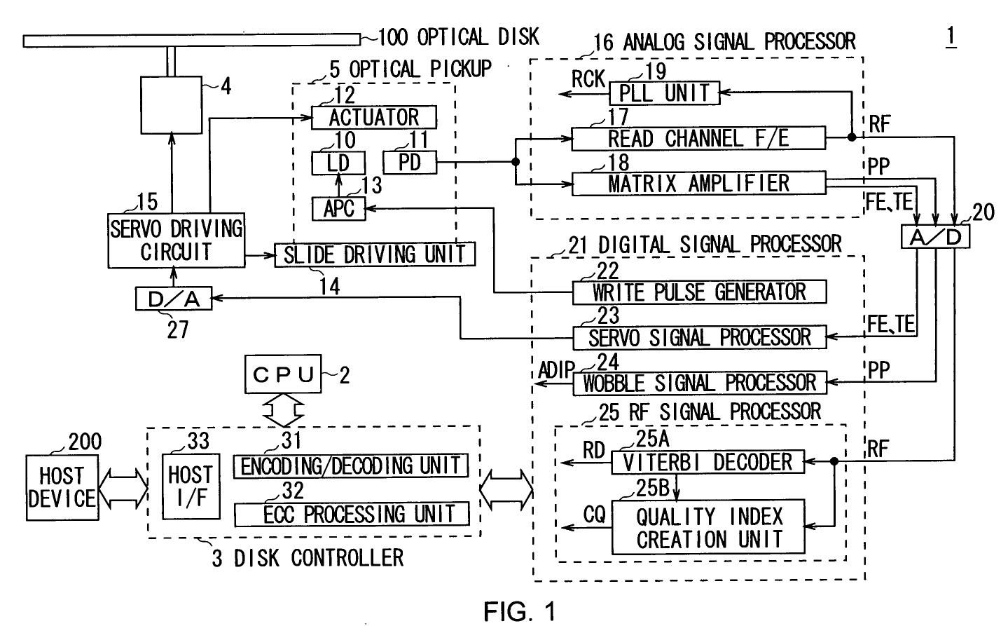

Referring to FIG. 1, reference numeral 1 shows a disk drive device according to this invention. A Central Processing Unit (CPU) 2 entirely controls the disk drive device 1 via a disk controller 3. The disk drive device 1 operates in response to read/write commands given from a host device 200, so as to record and reproduce data on/from an optical disk 100 serving as a recording medium.

The optical disk 100 is placed on a turn table which is not shown, and is rotated at a constant linear velocity (CLV) or a constant angular velocity (CAV) by means of a spindle motor 4. Then an optical pickup 5 reads data and Address In Pre-groove (ADIP) information from the optical disk 100, the data being recorded in the form of an emboss pit, a pigmentary change pit, or a phase change pit, the ADIP information being recorded in a wobbled groove.

The optical pickup 5 has a laser diode 10 serving as a laser light source, a photo detector 11 for detecting reflected light, a biaxial actuator 12 for holding objective lens which is an output end of laser light, an Automatic Power Control (APC) circuit 13 for controlling output of the laser diode 10, and optical systems, which are not shown, for irradiating a disk recording surface with laser light via the objective lens and guiding its reflected light to the photo detector 11.

The biaxial actuator 12 holds the objective lens so as to be movable in a tracking direction and a focus direction. Further, a slide driving unit 14 moves the optical pickup 5 in a disk radiation direction under the control of the servo driving circuit 15.

The photo detector 11 has a plurality of photo diodes. Each photodiode performs photoelectric conversion on reflected light received from the optical disk 100, and creates a received light signal according to the light amount of the received light and gives it to an analog signal processor 16.

A read channel front end 17 of the analog signal processor 16 creates a reproduced RF signal from the received light signal and gives it to an analog/digital converter 20. A matrix amplifier 18, on the other hand, performs matrix calculation of the received light signal received from each photodiode to create a focus error signal FE and a tracking error signal TE for servo control and a push/pull signal PP which is wobbled groove information, and gives these to the analog/digital converter 20. A PLL unit 19 generates a read clock RCK from the reproduced RF signal.

The analog/digital converter 20 digitizes the reproduced RF signal, the focus error signal FE, the tracking error signal TE, and the push/pull signal PP and gives the resultants to a digital signal processor 21.

The digital signal processor 21 has a write pulse generator 22, a servo signal processor 23, a wobble signal processor 24 and an RF signal processor 25.

The wobble signal processor 24 decodes the push/pull signal PP, extracts ADIP information including an address and physical format information, and gives it to the CPU 2.

The servo signal processor 23 creates various kinds of servo drive signals including focus, tracking, slide and spindle, based on the focus error signal FE and the tracking error signal TE, and gives them to the servo driving circuit 15 via the digital/analog converter 27.

The servo signal processor 23 gives a servo drive signal instructing to perform operation such as focus search, track jump and seeking, to the servo driving circuit 15 under the control of the CPU 2. The servo driving circuit 15 drives the biaxial actuator 12, the slide driving unit 14 and the spindle motor 4 according to the servo drive signal.

The RF signal processor 25 obtains reproduced data by performing Viterbi decoding on the reproduced RF signal read from the optical disk 100.

That is, a Viterbi decoder 25A of the RF signal processor 25 sequentially selects the maximum likelihood status which is assumed based on a status transition pattern specified by an RLL encoding method, based on the value (reproduced signal value) of a reproduced RF signal obtained at each timing specified by a read clock RCK. Then the Viterbi decoder 25A creates reproduced data RD based on the selected status data and gives the data to the disk controller 3.

At this time, a quality index creation unit 25B of the RF signal processor 25 obtains an amplitude reference value acxxx which is a logical value of an ideal reproduced RF signal without amplitude variation, based on a maximum likelihood status selected by the Viterbi decoder 25A. Further, the quality index creation unit 25B calculates an average value of differential values e[t] each between a reproduced signal value cxxx and the amplitude reference value acxxx of a reproduced RF signal at each sampling time.

This average value of differential values e[t] corresponds to a difference between an ideal waveform and an actual waveform of a reproduced RF signal and represents quality of the reproduced RF signal. The quality index creation unit 25B outputs the average value as a quality index value CQ representing the quality of the reproduced RF signal.

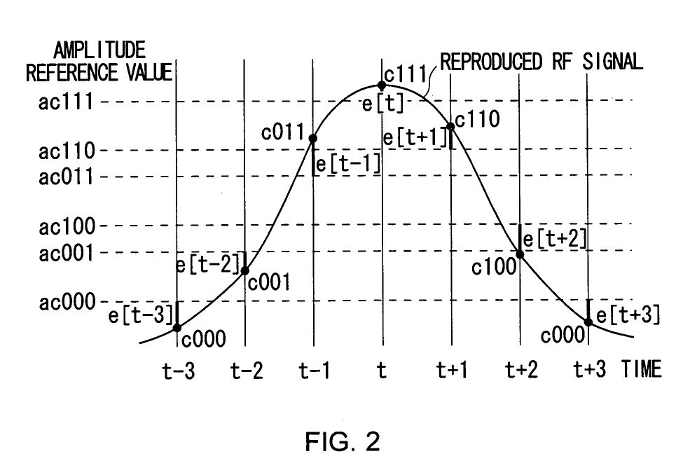

For example, as shown in FIG. 2, when the amplitude reference values at sampling times t−3, t−2, t−1, t, t+1, t+2, and t+3 are taken as ac000, ac001, ac011, ac111, ac110, ac100 and ac000 indicated by a dotted line and the reproduced signal values at these times are taken as c000, c001, c011, c111, c110, c100 and c000, the differential values at the sampling times are e[t−3]=ac000−c000, e[t−2]=ac001−c001, e[t−1]=ac011−c011, e[t]=ac111−c111, e[t+1]=ac110-c110, e[t+2]=ac100−c100, e[t+3]ac000−c000 indicated by a thick line.

The quality index creation unit 25 calculates a quality index value CQ by using an equation CQ=(e[t−3]+[t−2]+[t−1]+e[t]+e[t+1]+e[t+2]+2[t+3])/7.

The disk controller 3 has an encoding/decoding unit 31, an Error Correcting Code (ECC) processing unit 32, and a host interface 33.

In the disk controller 3, the encoding/decoding unit 31 decodes the reproduced data received from the RF signal processor 26 in reproduction, and the ECC processing unit 32 performs error correction and transfers the resultant to the external host device 200 (for example, personal computer) via the host interface 33.

In addition, the CPU 2 starts recording on the optical disk 100 in response to a write command from the host device 200.

That is, at the time of recording, in the disk controller 3, the ECC processing unit 32 adds an error correction code to recording data which is received from the host device 200 together with the write command, and the encoding/decoding unit 31 performs Run Length Limited (RLL) encoding on the recording data to create an RLL (1, 7) code and then gives the resultant to a write pulse generator 22 of the digital signal processor 21.

The write pulse generator 22 creates laser modulation data by performing waveform reformation on the recording data and sends this to the APC circuit 13. The APC circuit 13 drives the laser diode 10 with the laser modulation data, to irradiate the disk recording surface of the optical disk 100 with laser light at write power according to the laser modulation data, thereby writing data on the optical disk 100.

At this time, the CPU 2 sequentially changes an amount of correction of laser modulation data on the temporal axis and a write pulse width and so on, according to a recording strategy (described later) preset for each linear velocity of a Recording Unit Block (RUB) at which the optical pickup 5 writes data on the optical disk 100, thereby recording data so as to obtain a high- quality reproduced signal for each linear velocity. The RUB is a single unit to write data on a recording track.

By the way, when a plurality of small recording data of a prescribed size or smaller is supplied from the host device 200 together with a write command, the disk drive device 1 improves recording efficiency by controlling the servo driving circuit 15 to write data with the CAV method since seeking operation should be performed many times. In a case of a plurality of large recording data larger than a prescribed size, the disk drive device 1 improves recording efficiency by controlling the servo driving circuit 15 to write data with the CLV method since seeking operation is not required so many times. As a result, the CAV method and the CLV method can be adaptively switched.

(2) Recording Strategy

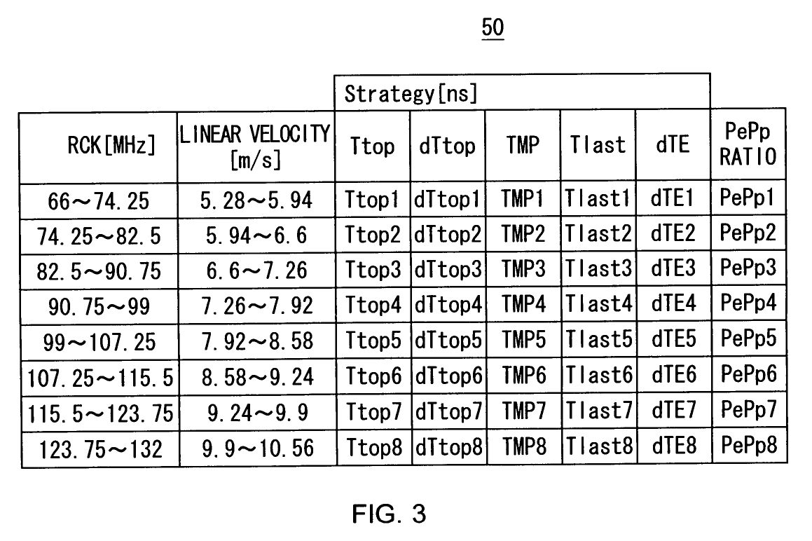

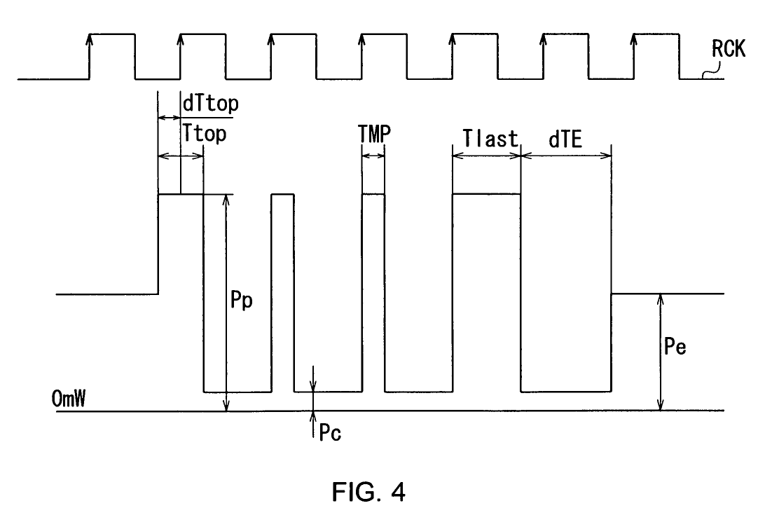

The recording strategy is information on recording conditions including an amount of correction of laser modulation data on a temporal axis and a write pulse width, and is stored as a strategy table in a Read Only Memory (ROM) of the CPU 2 which is not shown. Specifically, as shown in FIG. 3, the strategy table 50 specifies an amount of correction of laser modulation data on the temporal axis and the write pulse width shown in FIG. 4, for each linear velocity.

This strategy table 50 does not specify write power because it is a fixed value. This is because, in the disk drive device 1 of this embodiment, fine adjustment including write power adjustment by the APC circuit 13 for every linear velocity of the optical disk 100 requires many calculations and very complicated control. By fixing write power, simple control can be realized and a recording transfer rate can be increased.

However, when the disk drive device 1 writes data on the optical disk 100, it performs Optimum Power Control (OPC) on the most inner circumference side (in the fastest area) of the optical disk being rotated with the CAV method, to perform calibration only once to obtain the best recording characteristics.

Therefore, the disk drive device 1 finely adjusts the irradiation time and so on of laser light for every linear velocity with reference to the recording strategy table 50 with fixing write power set by the OPC control, thereby being capable of keeping recording characteristics regardless of linear velocity for recording data.

The recording strategy table 50 (FIG. 3) sets an irradiation time Ttop for first writing with laser light from the laser diode 10, a start shift time dTtop indicating difference between rising timing of a read clock RCK and rising timing of a write pulse, an irradiation time TMP for emitting laser light for the second and successive writing, an irradiation time Tlast for last writing, a cool time dTE for cooling without emitting laser light on the disk recording surface of the optical disk 100, and a power ratio PePp of Pe indicating a bottom level of laser light, peak power Pp in writing, and erase power Pe in erasing, for each frequency MHz of read clock RCK in writing data, that is, for each linear velocity m/s of RUB.

For example, in a case where the linear velocity of RUB on the most inner circumference side (in the fastest area) of the optical disk 100 is 9.9 to 10.56 m/s corresponding to a double speed (2×) when the optical pickup 5 performs the OPC control on the optical disk 100, the recording strategy shows an irradiation time of Ttop8, a start shift time dTtop8, an irradiation time TMP8, an irradiation time Tlast8, a cool time dTE8 and a power ratio PePp8.

After that, the linear velocity decreases as the optical pickup 5 moves from the most inner circumference to the most outer circumference, and the irradiation time Ttop, the start shift time dTtop, the irradiation time TMP, the irradiation time Tlast and the cool time dTE gradually become longer.

Then, in a case where the linear velocity of an RUB which is a data writing destination of the optical pickup 5 is 5.28 to 5.94 m/s corresponding a normal speed (1×), the recording strategy shows the irradiation time Ttop1, the start shift time dTtop1, the irradiation time TMP1, the irradiation time Tlast1, the cool time dTE1, and the power ratio PePp1.

As described above, the CPU 2 always recognizes the linear velocity of an RUB which is a data writing destination of the optical disk 100, reads the contents of the recording strategy corresponding to the linear velocity from the strategy table 50, and sets recording conditions for accessing the optical disk 100 by using the read contents.

Note that even when the disk drive device 1 performs writing with the CAV method or the CLV method, the CPU 2 recognizes the linear velocity of RUB which is a data writing destination, and sets the recording conditions for writing data based on the recording strategy according to the linear velocity.

(3) Recording Control Procedure

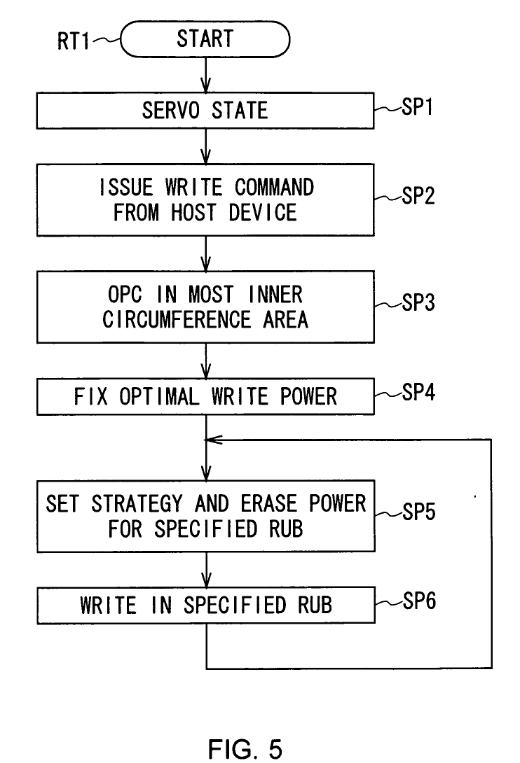

Next, a recording control procedure of the CPU 2 of the disk drive device 1 to control recording of data on an optical disk 100 with the strategy table 50 will be described with reference to the flowchart of FIG. 5.

The CPU 2 of the disk drive device 1 enters a start step of the routine RT1 and moves on to step SP1.

In step SP1, the CPU 2 of the disk drive device 1 rotates the optical disk 100 via the servo driving circuit 15 and sets the biaxial actuator 12 of the optical pickup 15 to a servo state, and then moves on to next step SP2.

In step SP2, when the CPU 2 recognizes that a write command has been issued from the host device 200 via the host interface 33, it moves on to next step SP3.

In step SP3, the CPU 2 performs the OPC control in an OPC area of 9.9 m/s to 10.56 m/s of which the linear velocity on the most inner circumference side of the optical disk 100 corresponds to a double speed (2×), and moves on to next step SP4.

In step SP4, with the OPC control, the CPU 2 fixes optimum write power of laser light at which the best recording characteristics may be obtained on the most inner circumference side (in the fastest area) of the optical disk 100, and moves on to next step SP5.

In step SP5, the CPU 2 recognizes the linear velocity of an RUB which has been specified by the write command as a writing destination, reads the recording strategy corresponding to the linear velocity from the strategy table 50, sets the recording conditions of the optical pickup 5 by using this and sets the erase power for the write power (fixed value) based on the PePp ratio, and then moves on to next step SP6.

The CPU 2 is designed to be capable of setting optimum erase power for each linear velocity by adjusting the erase power based on the PePp ratio since the write power keeps its fixed value. The adjustment of erase power for each linear velocity can previously avoid inconveniences including overheating of a disk recording surface and insufficient erase of data.

In step SP6, the CPU 2 writes or erases data in/from an RUB specified by the host device 200, with the recording conditions and erase power set in step SP5, and returns back to step SP5 and repeats this process.

(4) Recording/Reproducing Characteristics

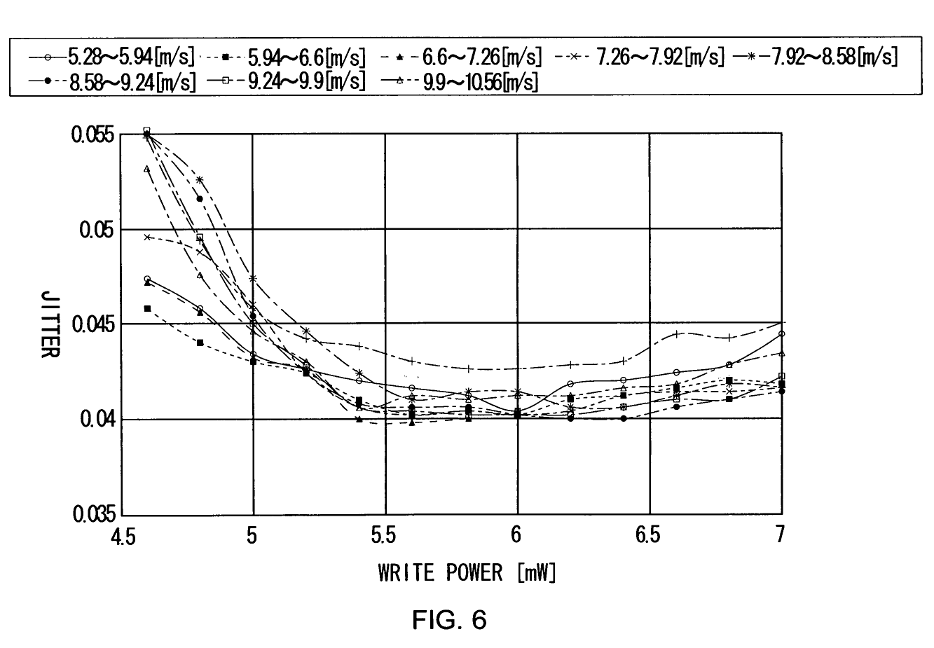

FIG. 6 shows recording/reproducing characteristics as a result of accessing data by the disk drive device 1 with the recording control procedure of the routine RT1. The horizontal axis of this graph shows write power of the optical pickup 5 and the vertical axis shows a difference (jitter) between an ideal waveform and an actual waveform of a reproduced RF signal. This figure shows jitter distribution for each linear velocity.

At the time of writing data, this disk drive device 1 sets write power to 6 mW at which the minimum jitter (about 0.04) can be obtained, so as to obtain the best recording characteristics in the OPC area of 9.9 m/s to 10.56 m/s in which the linear velocity on the most inner circumference side of the optical disk 100 corresponds to a double speed (2×), as described with reference to the above step SP3.

After that, the disk drive device 1 writes data with the write power of 6 mW fixed. Therefore, the disk drive device 1 irradiates the disk recording surface of the optical disk 100 with laser light at fixed write power of 6 mW, regardless of linear velocity.

Then, even when the linear velocity of an RUB which is a data writing destination varies, the disk drive device 1 reads the recording strategy corresponding to the linear velocity of the RUB from the strategy table 50 with the write power of 6 mW fixed, and corrects the write pulse of laser modulation data on the temporal axis by using this.

As a result of writing data on the optical disk 100 at each linear velocity, this graph shows that the minimum jitter can be obtained with write power of 6 mW, at any linear velocity.

In other words, the disk drive device 1 adjusts only recording strategy according to the strategy table without changing write power which is determined through the first OPC control, which can simplify the recording control process as compared with a case of controlling write power in the past, and increase a writing transfer rate with keeping the best recording characteristics and reducing calculation time.

(5) Operations and Effects

According to the above configuration, the disk drive device 1 determines write power at which jitter can be minimized, so that the best recording characteristics can be obtained in the fastest area (OPC area) of the most inner circumference side of the optical disk 100 rotating with the CAV method.

The disk drive device 1 previously stores recording strategies in the strategy table 50 so that jitter can be minimized for each linear velocity even with the determined write power fixed.

Then, by setting recording conditions suitable for the linear velocity at the time of writing data according to the strategy table 50, the recording characteristics can be kept without changing write power.

As described above, the disk drive device 1 sets recording strategies so that recording characteristics do not vary depending on linear velocity, and previously stores them in the ROM as the strategy table 50. This eliminates troublesome and complicated write power control for each linear velocity and can keep the best recording characteristics with simpler control than the patent reference 1.

In addition, the disk drive device 1 may perform calibration only once for the first OPC control, as write power setting. This can minimize the number of times of calibration and can further improve a data recording transfer rate as compared with a case of performing troublesome and complicated write power control for each linear velocity.

According to the above configuration, the disk drive device 1 can obtain the best recording characteristics only by adjusting the recording conditions for each linear velocity according to the strategy table 50 with the first determined write power fixed, resulting in being capable of improving a recording transfer rate with keeping the recording characteristics, with simpler control as compared with cases in the past.

(6) Other Embodiments

Note that the above embodiment has described a case where this invention is applied to the disk drive device 1 capable of adaptively switching between the CAV method and the CLV method. This invention, however, is not limited to this and can be applied to disk drive devices which operate with only the CAV method and disk drive devices which operate with other methods such as a Zone Constant Linear Velocity (ZCLV) method.

Further, the above embodiment has described a case where eight kinds of recording strategies are specified for each range of linear velocity in the strategy table 50. This invention, however, is not limited to this and plural kinds of recording strategies for more finely classified ranges of linear velocity can be specified in the strategy table 50.

Furthermore, the above embodiment has described a case where this invention is applied to the disk drive device 1 which writes and erases data on/from the optical disk 100 serving as a disk recording medium. This invention, however, is not limited to this and can be applied to other disk drive devices which access various kinds of disk recording media including Compact Discs-Recordable (CD-Rs), Digital Versatile Discs (DVDs), and Blu-ray discs.

Furthermore, the above embodiment has described a case where the disk drive device of this invention is composed of: the servo driving circuit 15 serving as a driving means; the optical pickup 5 serving as an access means for writing and erasing data on/from the optical disk 100 which is a disk recording medium being rotated by the servo driving circuit 15, according to a write pulse; the CPU 2 and the write pulse generator 22 serving as a write power setting means; and the CPU 2 serving as a control means. This invention, however, is not limited to this and the disk drive device can have different circuitry.

The disk drive device of this invention can be applied for various purposes including writing of data with the CAV method, the SCAV method, the CLV method, and the ZCLV method.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

1. A disk drive device for accessing a disk recording medium, comprising:
driving means for rotating the disk recording medium;
access means for writing or erasing data on/from the disk recording medium with a write pulse, the disk recording medium being rotated by the driving means;
write power setting means for setting write power in consideration of recording characteristics for writing the data on the disk recording medium at a prescribed linear velocity; and
control means for, when the access means writes or erases the data on/from the disk recording medium, correcting the write pulse on a temporal axis with the write power fixed even when the linear velocity of the disk recording medium varies.

2. The disk drive device according to claim 1, wherein
the control means has a table used for correcting the write pulse on the temporal axis according to change of the linear velocity.

3. The disk drive device according to claim 1, wherein
the control means switches a method of rotating the disk recording medium to a constant angular velocity method or a constant linear velocity method by controlling the driving means according to an amount of the data to be written on the disk recording medium.

4. The disk drive device according to claim 1, wherein
the control means adjusts only erase power by changing a power ratio of the write power and erase power for erasing the data, with the write power fixed.

5. The disk drive device according to claim 1, wherein
the driving means rotates the disk recording medium with a constant angular velocity method.

6. A disk access method for accessing a disk recording medium, comprising:
a write power setting step of setting write power in consideration of recording characteristics for writing data on the disk recording medium at a prescribed linear velocity when the data is written or erased on/from the disk recording medium with a write pulse, the disk recording medium being rotated by a driving means; and
a control step of, when the data is written or erased on/from the disk recording medium, correcting the write pulse on a temporal axis with the write power fixed even when the linear velocity of the disk recording medium varies.
